(19) United States
(12) Patent Application Publication
(10) Pub. No.: US 2013/0161884 A1
(43) Pub. Date: Jun. 27, 2013

(54) System and Method of Tuning a Liquid Inertia Vibration Eliminator

(71) Applicants: Maurice D. Griffin, Euless, TX (US); Scott Hemmen, Hurst, TX (US); Matt Ledbetter, Arlington, TX (US)

(72) Inventors: Maurice D. Griffin, Euless, TX (US); Scott Hemmen, Hurst, TX (US); Matt Ledbetter, Arlington, TX (US)

(73) Assignee: BELL HELICOPTER TEXTRON INC., FORT WORTH, TX (US)

(21) Appl. No.: 13/337,222

(22) Filed: Dec. 26, 2011

(51) Int. Cl. F16F 13/08

(52) U.S. Cl. 267/140.13

(57) ABSTRACT

A vibration isolator includes an upper housing and a lower housing; an upper reservoir housing defining a upper fluid chamber; a lower reservoir housing defining a lower fluid chamber; a piston spindle resiliently coupled to the upper housing with an upper elastomer member, the piston spindle being resiliently coupled to the lower housing with a lower elastomer member; an inertia track having a tuning passage, the inertia track being removably coupled to the piston spindle; and a tuning fluid disposed within the upper fluid chamber, the lower fluid chamber, and the tuning passage. The vibration isolator cancels vibratory forces at an isolation frequency, the isolation frequency being at least partially dependent upon a size of the tuning passage.

### BACKGROUND

1. Technical Field

The present application relates in general to vibration control. More specifically, the present application relates to methods and apparatus for isolating mechanical vibrations in structures or bodies that are subject to harmonic or oscillating displacements or forces. The present application is well suited for use in the field of aircraft, in particular, helicopters and other rotary wing aircraft.

2. Description of Related Art

For many years, effort has been directed toward the design of an apparatus for isolating a vibrating body from transmitting its vibrations to another body. Such apparatuses are useful in a variety of technical fields in which it is desirable to isolate the vibration of an oscillating or vibrating device, such as an engine, from the remainder of the structure. Typical vibration isolation and attenuation devices (“isolators”) employ various combinations of the mechanical system elements (springs and mass) to adjust the frequency response characteristics of the overall system to achieve acceptable levels of vibration in the structures of interest in the system. One field in which these isolators find a great deal of use is in aircraft, wherein vibration-isolation systems are utilized to isolate the fuselage or other portions of an aircraft from mechanical vibrations, such as harmonic vibrations, which are associated with the propulsion system, and which arise from the engine, transmission, and propellers or rotors of the aircraft.

Vibration isolators are distinguishable from damping devices in the prior art that are erroneously referred to as “isolators.” A simple force equation for vibration is set forth as follows:

F=m\ddot{x}+c\dot{x}+kx

A vibration isolator utilizes inertial forces (m\ddot{x}) to cancel elastic forces (kx). On the other hand, a damping device is concerned with utilizing dissipative effects (c\dot{x}) to remove energy from a vibrating system.

One important engineering objective during the design of an aircraft vibration-isolation system is to minimize the length, weight, and overall size including cross-section of the isolation device. This is a primary objective of all engineering efforts relating to aircraft. It is especially important in the design and manufacture of helicopters and other rotary wing aircraft, such as tilt rotor aircraft, which are required to hover against the dead weight of the aircraft, and which are, thus, somewhat constrained in their payload in comparison with fixed-wing aircraft.

Another important engineering objective during the design of vibration-isolation systems is the conservation of the engineering resources that have been expended in the design of other aspects of the aircraft or in the vibration-isolation system. In other words, it is an important industry objective to make incremental improvements in the performance of vibration isolation systems which do not require radical re-engineering or complete redesign of all of the components which are present in the existing vibration-isolation systems.

A marked departure in the field of vibration isolation, particularly as applied to aircraft and helicopters is disclosed in U.S. Pat. No. 4,236,607, titled “Vibration Suppression System,” issued 2 Dec. 1980, to Halwes, et al. (Halwes '607). Halwes '607 is incorporated herein by reference. Halwes '607 discloses a vibration isolator, in which a dense, low-viscosity fluid is used as the “tuning” mass to counterbalance, or cancel, oscillating forces transmitted through the isolator. This isolator employs the principle that the acceleration of an oscillating mass is 180° out of phase with its displacement.

In Halwes '607, it was recognized that the inertial characteristics of a dense, low-viscosity fluid, combined with a hydraulic advantage resulting from a piston arrangement, could harness the out-of-phase acceleration to generate counter-balancing forces to attenuate or cancel vibration. Halwes '607 provided a much more compact, reliable, and efficient isolator than was provided in the prior art. The original dense, low-viscosity fluid contemplated by Halwes '607 was mercury, which is toxic and highly corrosive.

Since Halwes' early invention, much of the effort in this area has been directed toward replacing mercury as a fluid or to varying the dynamic response of a single isolator to attenuate differing vibration modes. An example of the latter is found in U.S. Pat. No. 5,439,082, titled “Hydraulic Inertial Vibration Isolator,” issued 8 Aug. 1995, to McKeown, et al. (McKeown '082). McKeown '082 is incorporated herein by reference.

Several factors affect the performance and characteristics of the Halwes-type isolator, including the density and viscosity of the fluid employed, the relative dimensions of components of the isolator, and the like. One improvement in the design of such isolators is disclosed in U.S. Pat. No. 6,009,983, titled “Method and Apparatus for Improved Isolation,” issued 4 Jan. 2000, to Stamps et al. (Stamps '983). In Stamps '983, a compound radius at the each end of the tuning passage was employed to provide a marked improvement in the performance of the isolator. Stamps '983 is incorporated herein by reference.

Another area of improvement in the design of the Halwes-type isolator has been in an effort directed toward a means for changing the isolator's frequency in order to increase the isolator's effectiveness during operation. One development in the design of such isolators is disclosed in U.S. Pat. No. 5,435,531, titled “Vibration Isolation System,” issued 25 Jul. 1995, to Smith et al. (Smith '531). In Smith '531, an axially extendable sleeve is used in the inner wall of the tuning passage in order to change the length of the tuning passage, thereby changing the isolation frequency. Another development in the design of tunable Halwes-type isolators was disclosed in U.S. Pat. No. 5,704,596, titled “Vibration Isolation System,” issued 6 Jan. 1998, to Smith et al. (Smith '596). In Smith '596, a sleeve is used in the inner wall of the tuning passage in order to change the cross sectional area of the tuning passage itself, thereby changing the isolation frequency during operation. Both Smith '531 and Smith '596 were notable attempts to actively tune the isolator.

Another development in the area of vibration isolation is the tunable vibration isolator disclosed in U.S. Pat. No. 6,695,106, titled “Method and Apparatus for Improved Vibration Isolation,” issued 24 Feb. 2004, to Smith et al, which is hereby incorporated by reference.

Although the foregoing developments represent great strides in the area of vibration isolation, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of a helicopter according to the present application;

FIG. 2A is a plan view of a tilt rotor aircraft according to the present application in an airplane mode;

FIG. 2B is a perspective view of a tilt rotor aircraft according to the present application in a helicopter mode;

FIG. 3 is a perspective view of a quad tilt rotor aircraft according to the present application in an airplane mode;

FIG. 4 is a perspective view of a vibration isolator according to the preferred embodiment of the present application;

FIG. 5 is a front view of the vibration isolator according to the preferred embodiment of the present application;

FIG. 6 is a cross-sectional view of the vibration isolator, taken from section lines VI-VI in FIG. 5, according to the preferred embodiment of the present application;

FIG. 7 is a mechanical equivalent force diagram of the vibration isolator of FIGS. 4-6; and

FIG. 8 is a schematic diagram of a method for optimizing the isolation frequency of a vibration isolator, according to an embodiment of the present application.

### DESCRIPTION OF THE PREFERRED EMBODIMENT

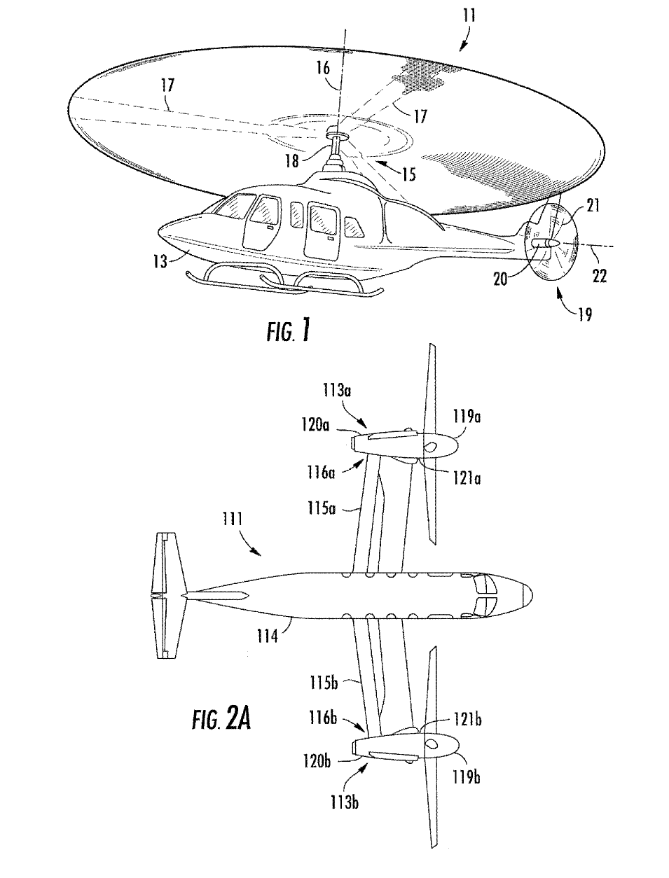

Referring to FIG. 1 in the drawings, a helicopter 11 according to the present application is illustrated. Helicopter 11 has a fuselage 13 and a main rotor assembly 15, including main rotor blades 17 and a main rotor shaft 18. Helicopter 11 has a tail rotor assembly 19, including tail rotor blades 21 and a tail rotor shaft 20. Main rotor blades 17 generally rotate about a vertical axis 16 of main rotor shaft 18. Tail rotor blades 21 generally rotate about a lateral axis 22 of tail rotor shaft 20. Helicopter 11 also includes a vibration isolation system according to the present application for isolating fuselage 13 or other portions of helicopter 11 from mechanical vibrations, such as harmonic vibrations, which are associated with the propulsion system and which arise from the engine, transmission, and rotors of helicopter 11.

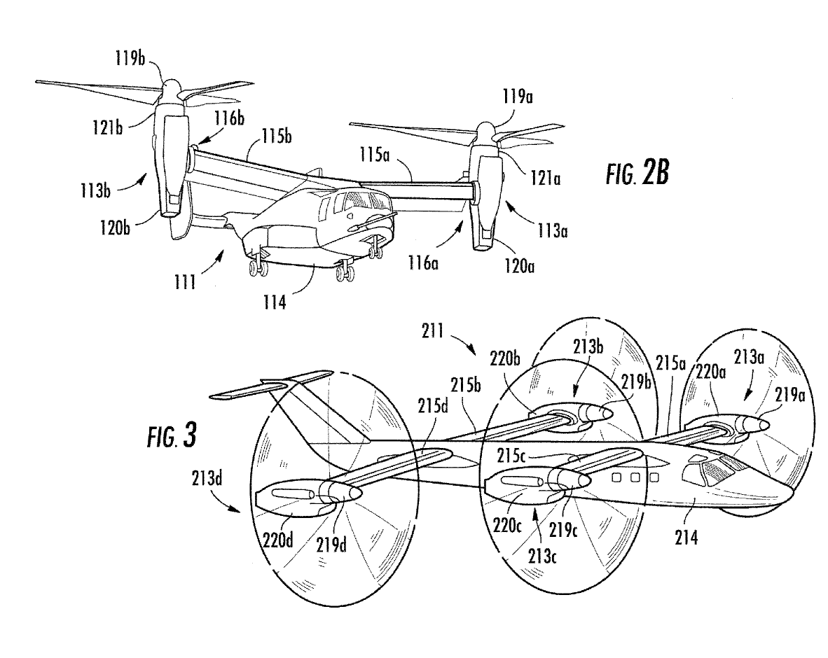

The system of the present application may also be utilized on other types of rotary wing aircraft. Referring now to FIGS. 2A and 2B in the drawings, a tilt rotor aircraft 111 according to the present application is illustrated. As is conventional with tilt rotor aircraft, rotor assemblies 113a and 113b are carried by wings 115a and 115b, and are disposed at end portions 116a and 116b of wings 115a and 115b, respectively. Tilt rotor assemblies 113a and 113b include nacelles 120a and 120b, which carry the engines and transmissions of tilt rotor aircraft 111, as well as, rotor hubs 119a and 119b on forward ends 121a and 121b of tilt rotor assemblies 113a and 113b, respectively.

Tilt rotor assemblies 113a and 113b move or rotate relative to wing members 115a and 115b between a helicopter mode in which tilt rotor assemblies 113a and 113b are tilted upward, such that tilt rotor aircraft 111 flies like a conventional helicopter; and an airplane mode in which tilt rotor assemblies 113a and 113b are tilted forward, such that tilt rotor aircraft 111 flies like a conventional propeller driven aircraft. In FIG. 2A, tilt rotor aircraft 111 is shown in the airplane mode; and in FIG. 2B, tilt rotor aircraft 111 is shown in the helicopter mode. As shown in FIGS. 2A and 2B, wings 115a and 115b are coupled to a fuselage 114. Tilt rotor aircraft 111 also includes a vibration isolation system according to the present application for isolating fuselage 114 or other portions of tilt rotor aircraft 111 from mechanical vibrations, such as harmonic vibrations, which are associated with the propulsion system and which arise from the engines, transmissions, and rotors of tilt rotor aircraft 111.

Referring now to FIG. 3 in the drawings, a quad tilt rotor aircraft 211 according to the present application is illustrated. As with the tilt rotor aircraft 111 of FIGS. 2A and 2B, rotor assemblies 213a, 213b, 213c, and 213d are carried by a forward wing 215a, 215c, and an aft wing 215b, 215d, respectively. Tilt rotor assemblies 213a, 213b, 213c, and 213d include nacelles 220a, 220b, 220c, and 220d, which carry the engines and transmissions of quad tilt rotor aircraft 211, as well as, rotor hubs 219a, 219b, 219c, and 219d on forward ends of tilt rotor assemblies 213a, 213b, 213c, and 213d, respectively.

Tilt rotor assemblies 213a, 213b, 213c, and 213d move or rotate relative to wing members 215a, 215b, 215c, and 215d between a helicopter mode in which tilt rotor assemblies 213a, 213b, 213c, and 213d are tilted upward, such that quad tilt rotor aircraft 211 flies like a conventional helicopter; and an airplane mode in which tilt rotor assemblies 213a, 213b, 213c, and 213d are tilted forward, such that quad tilt rotor aircraft 211 flies like a conventional propeller driven aircraft. In FIG. 3, quad tilt rotor aircraft 111 is shown in the airplane mode. As shown in FIG. 3, wings 215a, 215b, 215c, and 215d are coupled to a fuselage 214. Tilt rotor aircraft 211 also includes a vibration isolation system according to the present application for isolating fuselage 214 or other portions of quad tilt rotor aircraft 211 from mechanical vibrations, such as harmonic vibrations, which are associated with the propulsion system and which arise from the engines, transmissions, and rotors of quad tilt rotor aircraft 211. It should be understood that the system of the present application may be used with any aircraft on which it would be desirable to have vibration isolation, including unmanned aerial vehicles that are remotely piloted.

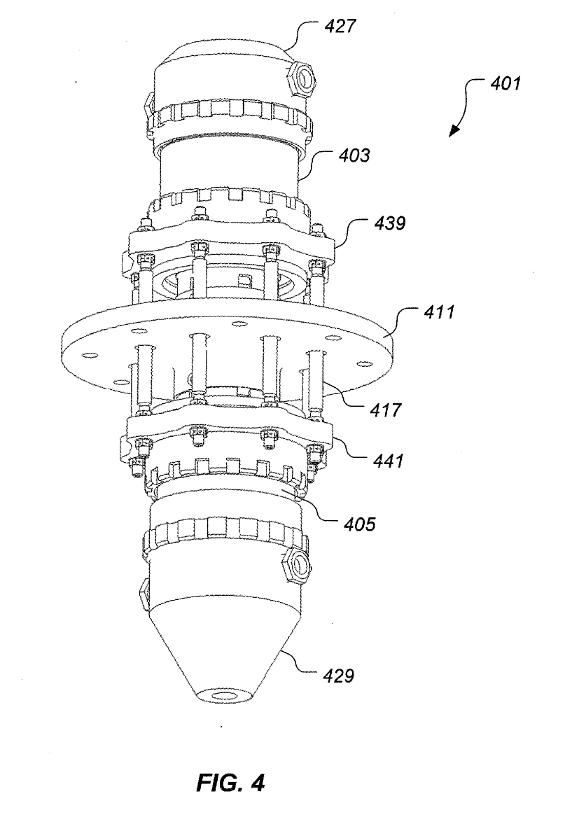

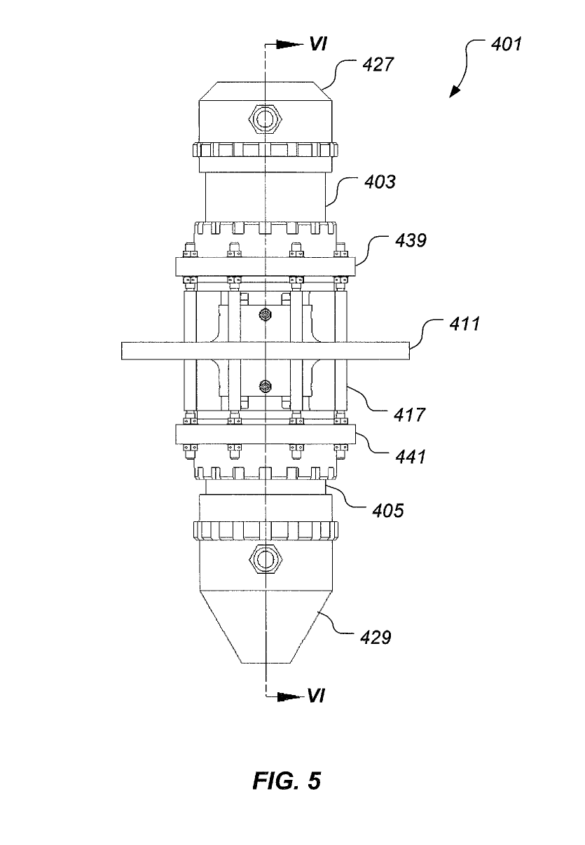

Referring now to FIGS. 4-6, a vibration isolator 401 according to the present application is illustrated. Isolator 401 comprises an upper housing 403 and a lower housing 405. An upper reservoir housing 427 and a lower reservoir housing 429 are coupled to end portions of upper housing 403 and a lower housing 405, respectively. Each upper reservoir housing 427 and a lower reservoir housing 429 define an upper fluid chamber 407 and a lower fluid chamber 409, respectively. A piston spindle 411 includes a cylindrical portion that is at least partially disposed within the interior of upper housing 403 and lower housing 405. A plurality of studs 417 rigidly couple together upper housing 403 and a lower housing 405 via an upper ring 439 and a lower ring 441, respectively, so that upper housing 403 and lower housing 405 function as a single rigid body. Studs 417 extend through piston spindle 411 through apertures sized to prevent any contact between studs 417 and piston spindle 411 during operation. Further, piston spindle 411 is resiliently coupled to upper housing 403 and lower housing 405 via an upper elastomer member 413 and a lower elastomer member 415, respectively.

Piston spindle 411 is preferably coupled to a vibrating body, such as a transmission of an aircraft via a pylon assembly. Either upper housing 403 or lower housing 405 can be coupled to a body to be isolated from vibration, such as a roof beam of an airframe of an aircraft. In such an arrangement, the airframe serves as the body to be isolated from vibration, and the transmission of the aircraft serves as the vibrating body. It should be appreciated that other portions of vibration isolator 401 can be coupled to the body to be isolated from vibration. For example, upper ring 439, lower ring 441, upper reservoir housing 427, and lower reservoir housing 429 also can be used as attachment locations for the body to be isolated from vibration.

Upper elastomer member 413 and lower elastomer member 415 seal and resiliently locate piston spindle 411 within the interior upper housing 403 and lower housing 405. Upper elastomer member 413 and lower elastomer member 415 function at least as a spring to permit piston spindle 411 to move or oscillate relative to upper housing 403 and lower housing 405. Upper elastomer member 413 and lower elastomer member 415 can be a solid elastomer member, or alternatively can be alternating layers of non-resilient shim members and elastomer layers.

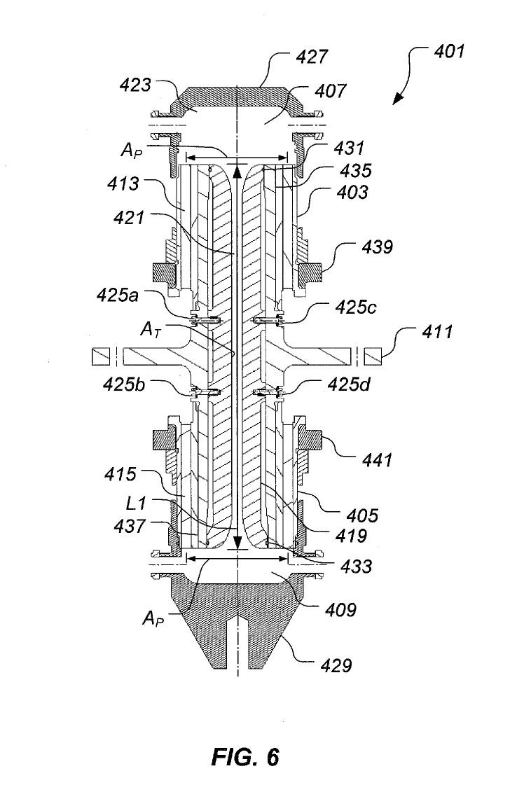

Isolator 401 further includes an inertia track 419 that defines a tuning passage 421. Tuning passage 421 axially extends through inertia track 419 to provide for fluid communication between upper fluid chamber 407 and lower fluid chamber 409. The approximate length of tuning passage 421 preferably coincides with the length of inertia track 419, and is further defined by L1 in FIG. 6. Tuning passage 421 is generally circular in cross-section and can be partially tapered longitudinally in order to provide efficient fluid flow.

A tuning fluid 423 is disposed in upper fluid chamber 407, lower fluid chamber 409, and tuning passage 421. Tuning fluid 423 preferably has low viscosity, relatively high density, and non-corrosive properties. For example, tuning fluid 423 may be a proprietary fluid, such as SPF I manufactured by LORD CORPORATION. Other embodiments may incorporate hydraulic fluid having suspended dense particulate matter, for example.

The introduction of a force into piston spindle 411 translates piston spindle 411 and inertia track 419 relative to upper housing 403 and lower housing 405. Such a displacement of piston spindle 411 and inertia track 419 forces tuning fluid 423 to move through tuning passage 421 in the opposite direction of the displacement of piston spindle 411 and inertia track 419. Such a movement of tuning fluid 423 produces an inertial force that cancels, or isolates, the force from piston spindle 411. During typical operation, the force imparted on piston spindle 411 is oscillatory; therefore, the inertial force of tuning fluid 423 is also oscillatory, the oscillation being at a discrete frequency, i.e., isolation frequency.

The isolation frequency (fᵢ) of vibration isolator 401 can be represented by the following equation:

$${f}_{i} = \frac{1}{2 π} \sqrt{\frac{K}{R ( R - 1 ) {m}_{t}}}$$

In the above equation, R represents the ratio of the functional area Aₚ of piston spindle 411 to the total area A_{T} inside the tuning passage 421. As such, R=Aₚ/A_{T} Mass of tuning fluid 423 is represented by mᵢ. The combined spring rate of elastomer members 413 and 415 is represented by K.

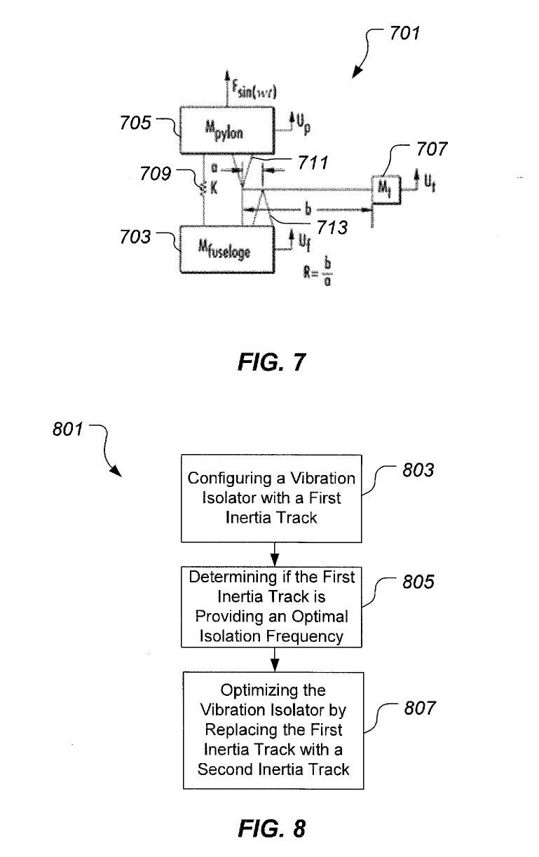

Referring briefly to FIG. 7 in the drawings, a mechanical equivalent model 701 for vibration isolator 401 of FIGS. 4-6 is illustrated. In mechanical equivalent model 701, a box 703 represents the mass of the fuselage M_{fuselage}; a box 705 represents the mass of the pylon assembly M_{pylon}; and a box 707 represents the mass of the tuning mass Mₜ, in this case, the mass of tuning fluid 423. A vibratory force F·sin(ωt) is generated by the transmission and propulsion system. Force F·sin(ωt) is a function of the frequency of vibration of the transmission and propulsion system.

Force F·sin(ωt) causes an oscillatory displacement uₚ of the pylon assembly; an oscillatory displacement of the fuselage u_{f}; and an oscillatory displacement of the tuning mass uₜ. Elastomer members 413 and 415 are represented by a spring 709 disposed between the fuselage M_{fuselage} and the pylon assembly M_{pylon}. Spring 709 has a spring constant K.

In mechanical equivalent model 701, tuning mass Mₜ functions as if cantilevered from a first fulcrum 711 attached to the pylon assembly M_{pylon}, and a second fulcrum 713 attached to the fuselage M_{fuselage}. The distance a from first fulcrum 711 to second fulcrum 713 represents the cross-sectional area of tuning passage 421, and the distance b from first fulcrum 711 to the tuning mass Mₜ represents the effective cross-sectional area of piston spindle 411, such that an area ratio, or hydraulic ratio, R is equal to the ratio of b to a. Mechanical equivalent model 701 leads to the following equation of motion for the system:

$$[ \begin{matrix}{M}_{pylon} + {( R - 1 )}^{2} {M}_{t} & - R ( R - 1 ) {M}_{t} \\ - R ( R - 1 ) {M}_{t} & {M}_{fuselage} + {R}^{2} {M}_{t}\end{matrix} ] \{ \begin{matrix}{\ddot{u}}_{p} \\ {\ddot{u}}_{f}\end{matrix} \} + [ \begin{matrix}K & - K \\ - K & K\end{matrix} ] \{ \begin{matrix}{u}_{p} \\ {u}_{f}\end{matrix} \} = \{ \begin{matrix}F sin ( ω t ) \\ 0\end{matrix} \}$$

As is evident, no means for actively tuning vibration isolator 401 is available. Once the cross-sectional areas of tuning passage 421 and piston spindle 411 are determined, and the tuning fluid is chosen, the operation of vibration isolator 401 is set. However, vibration isolator 401 is uniquely configured such that the isolation frequency can be selectively altered and optimized by the removing and replacing inertia track 419 with another inertia track 419 having a different diameter tuning passage 421. As such, vibration isolator 401 is uniquely adaptable to treat a variety of isolation frequencies, as well as being adaptable for variances in stiffness K of upper and lower elastomer members 413 and 415.

Referring again to FIGS. 4-6, inertia track 419 is configured to be removable from vibration isolator 401 by removing fasteners 425a-425d. Each fastener 425a-425d threadingly engages a threaded insert located in inertia track 419. In the preferred embodiment, lower reservoir housing 429 is removed from lower housing 405 so that inertia track 419 is can be removed. Inertia track 419 can then be replaced with another inertia track 419 having a larger or smaller tuning passage 421. The exact size of the tuning passage 421 is implementation specific and is determined by the desired isolation frequency. For example, if the actual vibratory force F·sin(ωt), generated by the transmission and propulsion system of an aircraft, is different than the predicted vibratory force or there is a variance in the stiffness K of upper and lower elastomer members 413 and 415 of vibration isolator 401, then vibration isolator 401 is configured so that inertia track 419 can be removed and replaced with a different inertia track 419 having a tuning passage 421 sized to provide an isolation frequency that cancels the actual vibratory force.

Inertia track 419 includes an upper seal 431 and a lower seal 433, each configured to mate against an upper portion 435 and lower portion 437 of piston spindle 411, respectively, so as to create a seal and prevent leakage of tuning fluid 423. Furthermore, an inner diameter surface of upper portion 435 of piston spindle 411 is narrower than an inner diameter surface of lower portion 437 of piston spindle. Consequently, the inertia track surface associated with upper seal 431 is narrower than the inertia track surface associated with lower seal 433. Such a geometric configuration prevents upper seal 431 and lower seal 433 from sliding against the entire length of the inner surfaces of piston spindle 411 during installation.

Referring now to FIG. 8, a method 801 of optimizing the isolation frequency of a vibration isolator is illustrated. Method 801 includes a step 803 of configuring a vibration isolator, such as vibration isolator 401 (shown in FIGS. 4-6), with a first inertia track, such as inertia track 419. As disclosed further herein, inertia track 419 includes a tuning passage 421 that affects the isolation frequency of the vibration isolator. Method 801 further includes a step 803 of determining if the first inertia track is providing an optimal isolation frequency. More specifically, step 803 can include measuring any vibration that is not cancelled by the vibration isolator and further analytically determining if the size of the tuning passage should be changed to more optimally cancel vibratory forces generated by the vibrating body. Method 801 further includes a step 805 of optimizing the vibration isolator by replacing the first inertia track with a second inertia track. In some embodiments, a variety of inertia tracks can be stocked so that the first inertia track can be quickly replaced. In another embodiment, the tuning passage of the first inertia track is machined to increase the diameter and reinstalled in the vibration isolator. Steps 805 and 807 can be iteratively performed until the vibration isolator is functioning at the optimal isolation frequency.

The system of the present application provides significant advantages, including: (1) providing a vibration isolator that is configured for efficient tuning to an optimal frequency by removing and replacing the inertia track; and (2) providing a vibration isolator with a removable inertia track so that the tuning port can be machined externally so as to prevent contamination of the vibration isolator during machining.

The particular embodiments disclosed above are illustrative only, as the application may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the application. Accordingly, the protection sought herein is as set forth in the claims below. It is apparent that a system with significant advantages has been described and illustrated. Although the system of the present application is shown in a limited number of forms, it is not limited to just these forms, but is amenable to various changes and modifications without departing from the spirit thereof.

1. A vibration isolator, comprising:
an upper housing and a lower housing;
an upper reservoir housing defining a upper fluid chamber;
a lower reservoir housing defining a lower fluid chamber;
a piston spindle resiliently coupled to the upper housing with an upper elastomer member, the piston spindle being resiliently coupled to the lower housing with a lower elastomer member;
an inertia track having a tuning passage, the inertia track being removably coupled to the piston spindle;
a tuning fluid disposed within the upper fluid chamber, the lower fluid chamber, and the tuning passage;
wherein the vibration isolator cancels vibratory forces at an isolation frequency, the isolation frequency being at least partially dependent upon a size of the tuning passage.

2. The vibration isolator according to claim 1, further comprising:
a removable fastener configured to couple the inertia track to the piston spindle.

3. The vibration isolator according to claim 1, wherein the upper elastomer member and the lower elastomer member include alternating layers of elastomer material and rigid shim members.

4. The vibration isolator according to claim 1, further comprising:
an upper seal associated with an upper portion of the inertia track.

5. The vibration isolator according to claim 1, further comprising:
a lower seal associated with a lower portion of the inertia track.

6. The vibration isolator according to claim 1, wherein the inertia track has a first outer diameter approximate an upper portion that is smaller than a second outer diameter approximate a lower portion.

7. The vibration isolator according to claim 1, wherein the piston spindle is configured for coupling to a vibrating body.

8. The vibration isolator according to claim 7, wherein the vibrating body is at least one of an aircraft engine, an aircraft transmission, an aircraft propeller, or an aircraft rotor.

9. The vibration isolator according to claim 1, wherein the piston spindle is configured for coupling to a pylon assembly of an aircraft.

10. The vibration isolator according to claim 1, wherein the tuning fluid has a low viscosity and a high density.

11. The vibration isolator according to claim 1, further comprising:
a plurality of studs rigidly attaching the upper housing to the lower housing.

12. The vibration isolator according to claim 11, wherein the plurality of studs each extends through apertures in the piston spindle.

13. A method of changing an isolation frequency in a vibration isolator, comprising:
configuring a vibration isolator with a first inertia track, the first inertia track having a first tuning passage;
determining if the first inertia track is providing an optimal isolation frequency;
optimizing the vibration isolator by replacing the first inertia track with a second inertia track having a second tuning passage.

14. The method according to claim 13, wherein the step of determining if the first inertia track is providing an optimal isolation frequency includes measuring any vibration that is being transferring from a vibrating body, through the vibration isolator, and into an isolated body.

15. The method according to claim 13, wherein the second tuning passage has a larger diameter than the first tuning passage.

16. The method according to claim 13, wherein the second tuning passage has a smaller diameter than the first tuning passage.

17. The method according to claim 13, wherein the step of optimizing the vibration isolator by replacing the first inertia track with a second inertia track having a second tuning passage includes removing fasteners that attach the first inertia track to a piston spindle in the vibration isolator.
